(19) United States
(12) Patent Application Publication
(10) Pub. No.: US 2006/0241946 A1
(43) Pub. Date: Oct. 26, 2006

(54) Speech input interface for dialog systems

(76) Inventor: Martin Oerder, Herzogenrath (DE)

Correspondence Address: PHILIPS INTELLECTUAL PROPERTY & STANDARDS, P.O. BOX 3001, BRIARCLIFF MANOR, NY, 10510, US

(21) Appl. No.: 10/567,398

(22) PCT Filed: Aug. 9, 2004
(86) PCT No.: PCT/IB04/51420

§ 371 Date: Feb. 7, 2006

(30) Foreign Application Priority Data
Aug. 12, 2003 (EP) 03102501.8

(51) Int. Cl. G10L 11/00; G10L 21/00

(52) U.S. Cl. 704/270.1

(57) ABSTRACT

A method is described for operation of a dialog system (1) with a speech input interface (2) and an application (3) co-operating with the speech input interface (2). The speech input interface (2) detects audio speech signals (AS) of a user and converts these into a recognition result (ER) in the form of binary data which can be used directly by the application. This recognition result (ER) is provided by the application (3). A method and a system for production of a corresponding speech input interface (2), a speech input interface (2) and a dialog system (1) with such a speech input interface (2), are also described.

The invention relates to a method for operation of a dialog system with a speech input interface. It also relates to a method and a system for production of a speech input interface, a corresponding speech input interface and a dialog system with such a speech input interface.

Speech-controlled dialog systems have a wide commercial application spectrum. They are used in speech portals of all types, for example in telephone banking, speech-controlled automatic goods output, speech control of handsfree systems in vehicles or in home dialog systems. In addition it is possible to use this technology in automatic translation and dictation systems.

In the development and production of speech dialog systems there is a general problem of reliably recognizing the speech input of a user of a dialog system, processing this efficiently and converting it into the system-internal reactions desired by the user. Depending on the size of the system and the complexity of the dialog to be controlled, there are many interconnected su-problems here: speech recognition usually breaks down into a syntactic substep which detects a valid statement, and a semantic substep which reflects the valid statement in its system-relevant significance. Speech recognition usually takes place with a specialist speech processing interface of the dialog system, which for example records the user's statement through a microphone, converts it into a digital speech signal and then performs the speech recognition.

The processing of the digital speech signal by speech recognition is largely performed by software components. Usually, therefore, the result of the speech recognition is the significance of a statement in the form of data and/or program instructions. These program instructions are finally executed or the data used and thus lead to the reaction of the dialog system intended by the user. This reaction can for example comprise an electronic or mechanical action (e.g. delivery of banknotes for a speech-controlled automatic teller machine), or data manipulation which is purely program-related and hence transparent to the user (e.g. change of account balance). Usually, therefore, the actual implementation of the meaning of a speech expression, i.e. the performance of the “semantic” program instructions, is performed by an application logically separate from the speech input interface, for example a control program. The dialog system itself is usually controlled by a dialog manager on the basis of a prespecified deterministic dialog description.

Depending on the stage of the dialog between the user and the dialog system, at a particular time the dialog system is in a defined state (specified by the dialog description) and on a valid instruction from the user converts into a correspondingly changed state. For each of these state changes the speech input interface must perform an individual speech recognition, since on each status transition other statements are recognized and must be unambiguously reflected in the correct semantics. Thus for example merely confirmation by “yes” is expected in one state, while in another case dedicated information (e.g. an account number) must be extracted from a complex statement. In practice on each status transition several synonymous statements are reflected in the same semantic meaning, e.g. the instructions “halt”, “stop”, “end” and “close” have the same objective namely the termination of a method.

There are different approaches for handling the complexity of the problem of understanding and further processing of a speech expression. In principle it is possible for each valid statement of each status change to contain a prototypical speech signal with which a concrete expression must be compared by syllable or word with random or spectral methods. An adequate reaction to a speech expression can be achieved in programming terms as a direct result of the recognition of a particular statement. In complex dialogs where it may be necessary in some cases to transmit detailed information, this rigid approach leads to the necessity firstly of having present all permitted synonymous variants of a statement in order to compare these as required with a user's statement, and secondly to process further user-specific information by special program routines. This makes this solution inflexible and very difficult for an operator of a dialog system to expand and adapt.

Another strategy takes the more dynamic, grammatical approach which for speech recognition uses linguistic grammatical models in the form of formal grammar. Formal grammar has algebraic structures which comprise substitution rules, terminal words, non-terminal words and a start word. These substitution rules prescribe rules according to which non-terminal words can be transferred (derived) structurally into word chains comprising non-terminal and terminal words. All sentences comprising only terminal words and generated from the start word by use of the substitution rule represent valid sentences of the language specified by the formal grammar.

In the grammatical approach, for each status change of a dialog system, the permitted sentence structures are prescribed generically by the substitution rules of a formal grammar and the terminal words specify the vocabulary of the language, all sentences of which are accepted as valid statements of a user. A concrete speech expression is thus verified by checking whether the use of the substitution rules and use of the vocabulary can be derived from the start word of the corresponding formal grammar. Phrases are possible also in which only the words with meaning are checked at the points of the sentence structure given by the substitution rules.

As well as this syntactic verification of a sentence, the speech recognition must allocate to each sentence its semantics, i.e. a significance which can be converted into a system reaction. The semantics comprise program instructions and/or data which can be applied by application of the dialog system. To allocate executable program instructions to the corresponding syntactic elements, frequently grammar is used which links the semantics with the associated terminal/non-terminal word in the form of an attribute. For so-called synthetic attributes, for non-terminal words the attribute value is calculated from the attribute of the last terminal words. For so-called inherited attributes, to calculate the attribute information from the superior non-terminal can also be used. The semantics of a speech expression are here implicitly generated as an attribute or attribute sequence on derivation of the sentence from the start word. Thus at least formally the direct depiction of the syntax in the semantics is possible.

U.S. Pat. No. 6,434,529 B1 discloses a system which uses an object-oriented program technology and identifies valid speech statements by means of formal grammar. The formal grammar and its check are implemented in this system by means of an interpreter language. Since for semantic conversion, the sentence element recognized as syntactically correct instantiates object-oriented classes in a translated (compiled) application program or its methods are executed, an interface is provided between the syntax analysis to be performed by an interpreter and the semantic conversion into the executable machine language application program.

This interface is implemented as follows: In the specification of the grammar or its substitution rules, semantic attributes are allocated to the terminal or non-terminal words in the form of script language program fragments. During syntactic derivation (parsing) of the speech statement according to the application sequence of the substitution rules, these semantic script fragments are converted into a hierarchical data structure which represents the spoken sentence in syntactic-structural terms. Then the hierarchical data structure is converted by further parsing into a table and finally constitutes a complete, linearly executable program language representation of the semantics of the corresponding statement, comprising script language instructions for the instantiation of an object or execution of a method in the application program. This representation can now be analyzed by a parser/interpreter as the corresponding objects are placed directly in the application program and the corresponding methods performed by this.

The disadvantages of this technology are partly evident even from its description. The use of a (sometimes proprietary) interpreter language for syntax analysis and a translator language for the application program requires a complex and complicated interface between the speech input interface and the application, which represent two completely different programming technologies.

Also it is not possible for a user to extend or change either the grammatical speech specification and the semantic script without further measures as first he must learn the special script language. In addition under certain circumstances an extension or change of semantics must be implemented and translated (compiled) by adaptation of corresponding semantic program fragments in the application too. Therefore in this technology the language cannot be varied or adapted during the run time of the dialog system. Since on conversion of the syntax to semantics (i.e. the run time of the dialog system), parsers or interpreters are used, in addition the care of the various system components constitutes an increased maintenance expenditure.

One object of the present invention is to make possible the operation and construction of a speech input interface of a dialog system so that the speech to be recognized can be defined by a simple, rapid and in particular easily modifiable specification of a formal grammar and speech statements can be reflected efficiently in semantics.

This object is achieved by a method for operation of a dialog system with a speech input interface and an application co-operating with a speech input interface in which the speech input interface detects audio speech signals of a user and converts these directly into a recognition result in the form of binary data and presents this result to the application for execution. Here binary data means data and/or program instructions (or references or pointers thereto) which can be used/executed directly by the application without further transformation or interpretation, where the directly executable data is generated by a machine language part program of the speech input interface. This means in particular the case where one or more machine language programming modules are generated a recognition result and presented to the application for direct execution. Secondly the object is achieved by a method for production of a speech input interface for a dialog system with an application co-operating with a speech input interface, which method comprises the following steps: specification of valid speech input signals by formal grammar, where the valid vocabulary of the speech input signal is defined as terminal words of the grammar, provision of binary data representing the semantics of valid audio speech signals and comprising data structures which are directly usable by the application for the system run time and generated by a program part of the speech input interface or program modules directly executable by the application, and/or the provision of program parts which generate the binary data; allocation of the binary data and/or program parts to individual or combinations of terminal words or non-terminal words to reflect a valid audio speech signal in appropriate semantics; translation of the program parts and/or program modules into machine language such that on operation of the dialog system, the translated program parts generate data structures directly usable by the application or on operation of the dialog system, the translated program modules can be executed directly by the application, where the data structures/program modules constitute the semantics of a speech statement.

According to the invention then the user's speech statement converted into an audio signal is transformed by the speech input interface of the dialog system directly into binary data which represents the semantic conversion of the speech input and hence the recognition result. This recognition result can be used directly by the application program co-operating with the speech input interface. The fact that these binary data in particular can comprise one or more machine language program modules which can be executed directly by the application is achieved for example by the speech input interface being written in a translator language and the program modules of the recognition result also being implemented in a translator language, where applicable a different language. Preferably these program modules are written in the same language in which the speech recognition logic was implemented. They can however also be written and compiled in a language which works on the same platform as the speech input interface. Depending on the translator language used, this makes it possible to present to the application program as a recognition result for direct execution either the executable program modules as such or references or pointers to these modules.

It is particularly advantageous to use an object-oriented programming language as firstly this can present the program modules of the application in the form of objects or methods of objects for direct execution and secondly the data structures to be used directly by the application can be represented as objects of an object-oriented programming language.

This invention offers many advantages. By implementing the speech recognition of the speech input interface, in particular semantic synthesis, as a machine program directly executable by a processor (in contrast to a script program which can only be executed via an interpreter), it is possible to generate directly a recognition result which can be used directly by a machine language application program. This gives maximum possible efficiency in conversion of the speech statement into an adequate reaction of the dialog system. In particular this renders superfluous the complex and technically complicated depiction of the semantic attributes or script program fragments, obtained by a script language parser from formal grammar, in a machine language representation. Further advantages arise from the possibility of being able to use, in the construction or specification of a speech input interface by a service provider or in its adaptation to new facts (e.g. special offers for a vending machine), conventional programming languages such as C, C++, C# or Java instead of proprietary script languages of the manufacturer of the speech input interface. Such languages are at least sufficiently widely known to a broad user spectrum that the syntax of the speech statements to be understood by the system or the associated semantic program modules can easily be adapted or extended often without great effort via a corresponding input interface. It is therefore no longer necessary to learn a proprietary language in order to reconfigure or update the dialog system. For the manufacturer the use of a translator language also brings the advantage of simpler and hence cheaper software maintenance of the system, as conventional standard compilers can be used and maintenance or further development of a specific script language and the corresponding parser and interpreter are no longer necessary.

The conversion of the speech statement into semantic program modules in the simplest case can take place by direct and clear allocation of the possible speech statements to the corresponding program modules. A more flexible, extendable and efficient speech recognition is however obtained by the methodic separation of the speech recognition into a syntax analysis step and a semantic synthesis step. By definition of the language to be understood by the speech input interface by means of a formal grammar, the syntax analysis i.e. the checking of a speech statement, is formalized for validity and separated from the semantic conversion. The valid vocabulary of the language arises from the terminal words of the grammar while the sentence structure is determined via the substitution rules and the non-terminal words. As both the syntax analysis and the semantic synthesis are performed by one or more machine programs, the recognition result of a speech statement is generated directly in the form of binary data in particular program modules which can be used/executed directly by the application. Examples are a program module which can be processed linearly by a processor and is derived from the traversing of the derivation tree of a valid speech statement on allocation of a semantic machine language program fragment to each terminal and non-terminal word by an attributed grammar. Another example would be a binary data structure which describes a time and is synthesized from its constituents as an attribute of a time grammar.

In many cases the grammar is defined completely before commissioning the dialog system and remains unchanged during operation. Preferably however a dynamic change of grammar is possible during operation of the dialog system as the syntax and semantics of the language to be understood by the dialog system are provided for the application for example in the form of a dynamic linked library. This is a great advantage in the case of frequent changes of speech elements or semantic changes, for example on special offers or changing information.

Particularly preferably the speech recognition is implemented in object-oriented translator language. This offers an efficient implementation, easily modifiable by the user, of generic standard substitution rules of formal languages e.g. a terminal rule, a chain rule and an alternative rule, as object-oriented grammar classes. The common properties and functions, in particular a generic parsing method, of these grammar classes can for example be inherited from one or more non-specific base classes. Similarly the base classes can pass on virtual methods to the grammar classes by inheritance, which can be over-written or reloaded where necessary to achieve concrete functionalities such as for example particular parsing methods. With the corresponding constructors provided in the class definitions concerned, the grammar of a concrete language can be specified by instantiation of the generic grammar classes. Here by the definition of terminal and non-terminal words, concrete substitution rules can be generated as program language objects. Each of these grammar objects then has an individual evaluation or parsing method which checks whether the corresponding rule can be applied to the phrase detected. Suitable use of substitution rules and hence the validity checking of the entire speech signal or the detection of the corresponding phrase is controlled by the syntax analysis step of the speech recognition.

By the consistent implementation of the systematizing concept of the present invention, in a preferred embodiment the methodic separation between syntax analysis and semantic analysis is retained while the temporal separation of their use is at least partly eliminated for the purposes of increased efficiency and shorter response times. When attributed grammar is used, during derivation from the start word of a speech signal to be recognized, the corresponding semantic binary data (attribute) of an applicable substitution rule is generated directly. Thus for example in the rule <“quarter to”<numeral from 1 to 12>>, as soon as the numeral is known as a result of the rule <numeral from 1 to 12>, a corresponding time data structure can be generated, in this case with the value “11:45”. If however on further uses of suitable substitution rules the parameters necessary for performance of a semantic program module are known, this program module can be executed directly by the speech input interface. The semantics are therefore at first not extracted completely from the speech signal but converted and executed quasi-parallel even during syntactic checking. Instead of references to executable program fragments and corresponding parameters, the speech input interface supplies the results—where applicable to be calculated by the application—directly to the application program. This particularly advantageous embodiment is possible by implementation of the syntactic check for speech recognition, the semantic program module and the application program as machine language programs, since the program units of the dialog system can hence communicate and exchange data efficiently via suitable interfaces.

In an object-oriented structure of the speech input interface, using attributed grammar the semantic program modules can be implemented as program language objects or methods of objects. This additional systematization of the semantic side is supported by the present invention as the grammar classes can be instantiated such that instead of the standard values (e.g. individual or lists of known terminal and non-terminal words), they return “semantic” objects which are defined by overwriting virtual methods of the grammar class concerned. Thus on application of corresponding substitution rules (i.e. when parsing the speech signal), semantic objects are returned which are calculated from the values returned during parsing.

The method according to the invention described above for production of a speech input interface offers the possibility of a simple, rapid and low-fault production or configuration of speech processing interfaces. To specify the language to be recognized, first a formal grammar is defined generically by determining the valid vocabulary of the language by the terminal words and the valid structure of the speech statements by the substitution rules or non-terminal words. After specification of this syntactic level, the semantic level is specified by the provision of program modules written in a translator language, the machine language translations of which can be combined suitably in the run time of the dialog system to reflect the syntactic structure in the corresponding semantics of a speech statement; furthermore binary data can be specified and/or program parts which suitably combine the binary data and/or program modules at run time. A clear allocation is defined between the syntactic and semantic levels so that to each terminal and non-terminal word is allocated a program module describing its semantics. As the semantic program modules are implemented in a translator language (e.g. C, C++ etc.), after definition they must be translated with the corresponding compiler so they can be presented for direct execution on operation of the dialog system.

This method has several advantages. Firstly it allows a service provider who designs or configures the speech input interface for particular applications to specify the syntax and semantics in a very simple manner by means of a known translator language. He need not therefore learn the sometimes complex proprietary (script) language of the manufacturer. In addition because of checking by the translator and the manipulation security of the machine programs, the use of a translator language is less susceptible to error and can be implemented more stably and more quickly for the end customer.

After specification of the semantics the translated semantic program modules can be presented to the dialog system of an end customer, for example as dynamic or static libraries. In the case of a dynamic linked library the application program of the dialog system need not be retranslated after provision of modified semantic program modules since it can contact the executing program module via references. This has the advantage that the semantics can be changed during operation of a dialog system, for example if a vending or order dialog system must be updated regularly as interruption-free as possible for frequently changing offers.

In an advantageous embodiment of this method to specify the grammar and its allocated semantics an object-oriented programming language is used. The formal grammar of the speech statements to be recognized can be specified as instances of grammar classes which implement generic standard substitution rules and inherit their common properties and functionalities from one or more grammatical base classes. The base classes for example provide generic parser methods which on specification of the grammar must be adapted to the substitution rules actually instantiated with terminal and non-terminal words at grammar class level. For efficient specification of grammar, it is sensible to provide grammar class hierarchies and/or grammar class libraries which already define a multiplicity of possible grammars and which can be used for reference when required.

Similarly the base classes can provide virtual methods which can be overwritten on use of an attributed grammar with methods which generate a corresponding semantic object. In this case on operation of the dialog system the semantic conversion is carried out by the application program without being separated temporally from the syntactic check, the semantics being executed directly during the syntax analysis.

In a method according to the invention to generate a dialog system with a speech interface which was developed according to the method described above, it is advantageous to write both the program input interface and the application program in the same—possibly object-oriented—translator language or in a translator language which can be reflected in the same object-oriented platform. As a result necessarily both the formal grammar and the corresponding program modules to reflect the syntax of a speech statement in the corresponding semantics are implemented in this language.

To produce such a speech input interface according to the said method, a system is provided for the developer or service provider which contains tools for syntax specification and semantic definition for specification of a formal grammar and suitable semantics. Using the syntax specification tool by means of the method described above a formal grammar can be specified by means of which the valid speech signals can be identified. The semantic definition tool supports a developer in the preparation or programming of the semantic program module and their clear allocation to individual terminal or non-terminal words of the grammar. The program modules translated into machine language can be executed directly by the application program. In the case of generation of data structures which can be used directly by the application, these are generated by the part programs of the speech input interface present in machine language.

In a particularly advantageous embodiment, the grammar developer has access to a graphic development interface as a front end of the syntax specification and/or semantic definition tool which has a grammar editor and where applicable a semantic editor. Where the speech recognition of the speech input interface is written in an object-oriented translator language, the grammar editor provides an extended class browser which allows simple selection of base classes and inheritance of their functionalities by graphic means (e.g. by “drag and drop”). The instantiation of standard substitution rules by terminal and non-terminal words and/or parsing methods, and where applicable methods for definition of semantic objects, can be performed via a special graphic interface which directly associates such data with the corresponding grammar class and converts it automatically by programming i.e. generates the corresponding source code. For a better distinction of base classes, derived classes, their methods and semantic conversions, adequate graphic symbols are used.

To program the sometimes complex semantic program modules preferably a development environment is provided which for example comprises class browser, editor, compiler, debugger and a test environment, allows an integrated development and compiles the corresponding program fragments in some cases into grammar classes or generates independent dynamic or static libraries.

The invention will be further described with reference to examples of embodiments shown in the drawings, to which however the invention is not restricted. These show:

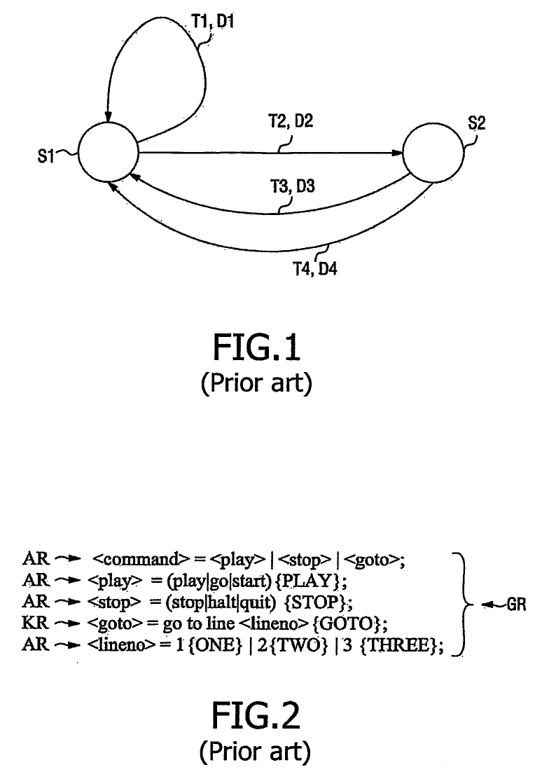

FIG. 1 a dialog of a dialog system;

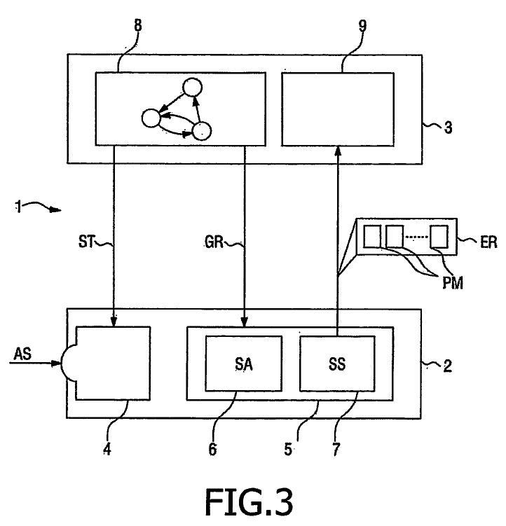

FIG. 2 a specification of a formal grammar;

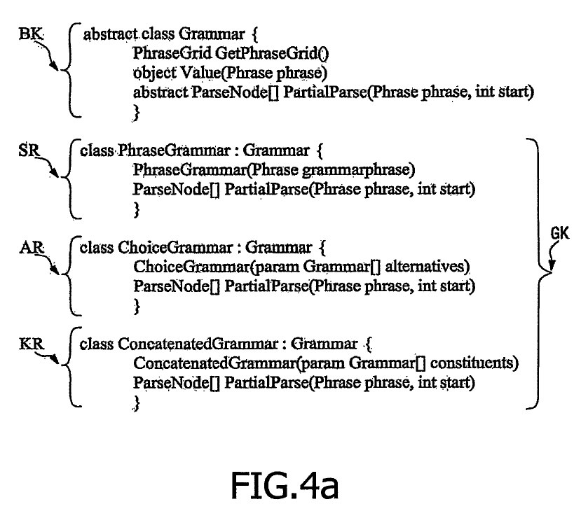

FIG. 3 a diagrammatic view of the structure of an example of embodiment of a dialog system according to the invention with a speech input interface;

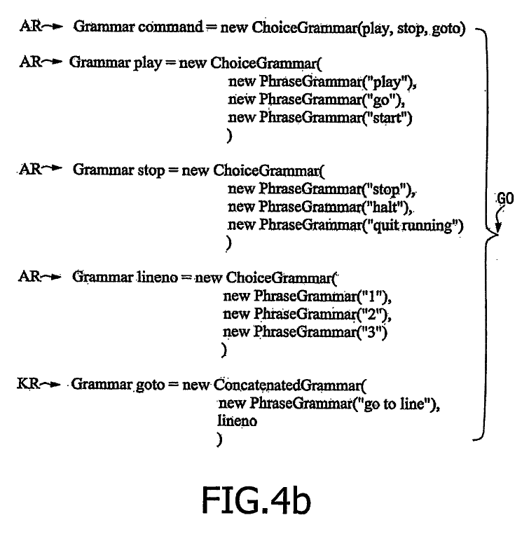

FIG. 4a a definition of grammar classes;

FIG. 4b a definition of grammar objects as instances of grammar classes;

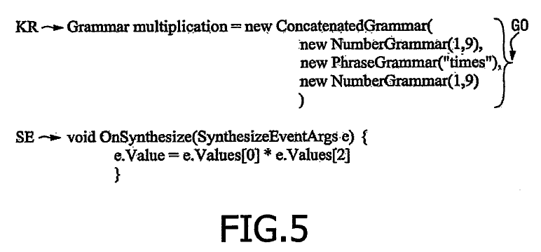

FIG. 5 a semantic implementation of a grammar object;

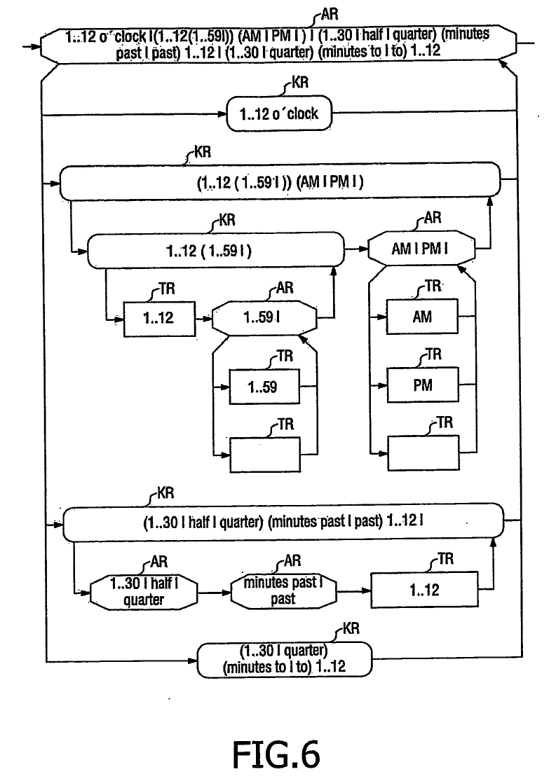

FIG. 6 a graphic structure of a grammar.

Formally, a dialog system can be described as an endless automaton. Its deterministic behavior can be described by means of a state/transition diagram which describes completely all states of the system and the events which lead to a state change, the transitions. FIG. 1 shows as an example the state/transition diagram of a simple dialog system 1. This system can assume two different states, S1 and S2, and has four transitions T1, T2, T3 and T4 which are each initiated by a dialog step D1, D2, D3 and D4, where transition T1 reflects state S1 in itself, while T2, T3 and T4 cause state changes. State S1 is the initial or starting state of the dialog system which is resumed at the end of each dialog with the user. In this state the system generates a starting expression which for example invites the user to make a statement: “What can I do for you?”. The user now has the choice of two speech expressions “What time is it?”, (dialog step 1) and “What is the weather forecast?” (dialog step 2). In dialog step 1 the system answers with the correct time and then completes the corresponding transition T1, returning to start state S1 and emitting the starting expression again. In dialog step D2 the system asks the user to specify his request more precisely by responding with the question: “For tomorrow or next week?” and via transition T2 changes to new state S2. In state S2 the user can answer the system's question only with D3 “Tomorrow” or D4 “Next week”; he does not have the option of asking the time. The system answers the user's clarification in dialog steps D3 and D4 with the weather forecast and via the corresponding transitions T3 and T4 returns to the starting state S1.

To be able to perform the individual dialog steps and respond adequately to the user's statement, it is necessary first to recognize correctly the user's speech statement and then convert this into the reaction wished by the user, i.e. to understand the statement. Naturally for reasons of user-friendliness and acceptance it is desirable for the dialog system in a particular state to be able to process several equivalent user statements. For example the dialog system described in FIG. 1 on transition T1 should not only understand the specific dialog step D1 but be able to respond correctly to synonymous inquiries such as “What time is it?” or “How late is it?”. In addition realistic systems in one state often provide a large number of possible dialog steps which initiate a multiplicity of different transitions. Apart from the trivial and usually impracticable solution of storing in the system all possible dialog steps for comparison with the respective user enquiry together with the corresponding system reactions, in such cases it is sensible to specify the possible user statements by a formal grammar GR.

FIG. 2 shows an example of a formal grammar GR for voice command of a machine. The grammar GR comprises the non-terminal words <command>, <play>, <stop>, <goto>, and <lineno>, the terminal words “play”, “go”, “start”, “stop”, “halt”, “quit”, “go to line”, “1”, “2” and “3”, and the substitution rules AR and KR which for each non-terminal word prescribe a substitution by non-terminal and/or terminal words. Depending on their function the substitution rules are divided into alternative rules AR and chain rules KR, where the start symbol <command> is derived from an alternative rule. An alternative rule AR replaces a non-terminal word by one of the said alternatives and a chain rule KR replaces a non-terminal word by a series of further terminal or non-terminal words. Starting with the initial replacement of the start word <command>, all valid sentences i.e. valid rows of terminal words of the language specified by the formal grammar GR can be generated in the form of a derivation or substitution tree. So by sequential substitution of the non-terminal symbols <command>, <goto> and <lineno> for example the sentence “go to line 2” is generated and defined as a valid speech statement, but not the sentence “proceed to line 4”. This derivation of a concrete sentence from the start word represents the step of syntax analysis.

As the grammar GR shown in FIG. 2 is an attributed grammar, it allows direct reflection of the syntax in the semantics i.e. into commands which can be executed/interpreted by the application 3. These are already specified in the grammar GR for each individual terminal word—given in curved brackets. The statement “goto line 2”, recognized as valid in syntax analysis SA, is semantically converted into the command “GOTO TWO”. By reflecting several syntactic constructs in the same semantics, synonymous statements can be taken into account. For example the statements “play”, “go” and “start” can be semantically reflected in the same command “PLAY” and lead to the same reaction of the dialog system 1.

An example of embodiment of a dialog system 1 with a speech input interface 2 according to the invention and an application 3 co-operating with the speech input interface is shown in FIG. 3. The application 3 comprises a dialog control 8 which controls the dialog system 1 according to the states, transitions and dialogs established in the state/transition diagram.

An incoming speech statement is now first converted as usual from a signal input unit 4 of the speech input interface 2 into a digital audio speech signal AS. The actual method of speech recognition is initiated by the dialog control 8 by the start signal ST.

The speech recognition unit 5 integrated into the speech input interface 2 comprises a syntax analysis unit for performance of the syntax analysis SA and a semantic synthesis unit for performance of the subsequent semantic synthesis SS. The formal grammar GR to be checked in the syntax analysis step (or a data structure derived from this which is used directly by the syntax analysis) is given to the syntax analysis unit 6 by the dialog control 8 according to the actual state of dialog system 1 and the expected dialogs. The audio speech signal AS is verified according to this grammar GR and if valid reflected by the semantics synthesis unit 7 in its semantics.

There are two variants for definition of semantics. Unless specified otherwise, it is assumed below that without restriction of the invention, the recognition result ER is one or more program modules. Here the semantics arise directly from the direct allocation of terminal and non-terminal symbols to machine language program modules PM which can be executed by a program execution unit 9 of the application 3. The machine language program modules PM of all terminal and non-terminal words of a fully derived speech statement are combined by the semantic synthesis unit 7 into a machine language recognition result ER and provided to the program execution unit 9 of the application 3 for execution or presented to it as directly executable machine programs.

For a complete description of the invention it should also be explained that in a second variant data structures can also be allocated to the terminal and non-terminal words, which structures are generated directly from machine language program parts of the speech input interface 2 and represent a recognition result ER. These data structures can then be used by the application 3 without further internal conversion, transformation or interpretation. It is also possible to combine the two said variants so that the semantics are defined partly by machine language program modules and partly by data structures which can be used directly by the application.

Both the speech recognition unit 5 of the speech input interface 2 and the application program 3 are here written in the same object-oriented translator language or a language which can run on the same object-oriented platform. The recognition result ER can thus be transferred very easily by the transfer of references or pointers. The use of an object-oriented translator language, in particular in the above combination of semantic program modules and data structures, is particularly advantageous. The object-oriented program design implements both the grammar GR and the recognition result ER in the form of program language objects as instances of grammar classes GK or as methods of these classes. FIGS. 4a, 4b and 5 show this method in detail.

Starting from the definition of formal grammar GR in FIG. 2, FIG. 4a shows the implementation of suitable grammar classes GK to convert the formal definition into an object-oriented programming language. All grammar classes GK are here derived from an abstract grammatical base class BK which passes on its methods to its derivative grammar class GK. In the example of embodiment shown in FIG. 4a there are three different derived grammar classes GK which are implemented as possible prototypical substitution rules in the form of a terminal rule TR, an alternative rule AR and a chain rule KR.

The abstract base class BK requires the methods GetPhaseGrid( ), Value( ) and PartialParse( ) where the method GetPhaseGrid( ) is used to initialize the speech recognition method in signal terms and need not be considered for an understanding of the syntactic recognition method. Apart from GetPhaseGrid( ), the only function to be contacted from the outside is the method Value( ) which evaluates the sentence given to it with the argument “phrase” and thus ensures access to the central parsing function. Value( ) returns the semantics as a result. In a simple case this can be a list showing separately the recognized syntactic units of the sentence. According to the formal grammar GR from FIG. 2, for example for the phrase “goto line” the list (“go to line”, “2”) is generated. In other cases the data can be processed further as in the above example of time grammar. The mechanism for this is described in more detail below. This result of syntax analysis SA is then converted semantically into a machine language program or a data structure and presented to the application 3 for direct execution/use. As the working method of the superior parsing method Value( ) depends on the applicable substitution rules, Value( ) recourses internally to the abstract method PartialParse( ). This cannot however be implemented in base class BK but only through the derived grammar class GK

The parsing function required in the base class BK of the PartialParse( ) method is thus implemented in the grammar class GK. As well as this rule-dependent parsing method the derived grammar classes GK have specific so-called constructors (PhaseGrammar( ), ChoiceGrammar( ), ConcatenatedGrammar( )) with which for run time of the syntax analysis SA instances of these classes i.e. grammar objects GO can be generated. The derived grammar classes TR, AR and KR thus constitute the program language “framework” for implementing a concrete substitution rule of a particular formal grammar GR. The constructor of the terminal rule TR PhaseGrammar only requires the terminal word which is to be replaced by a particular non-terminal word. The constructor of the alternative rule AR ChoiceGrammar requires a list with possible alternative replacements, while the constructor of the chain rule KR ConcatenatedGrammar requires a list of terminal and/or non-terminal words to be arranged in sequence. Each of these three grammar classes GK implements in an individual way the abstract PartialParse( ) method of the base class BK.

Starting from the grammar class GK defined in FIG. 4a, FIG. 4b shows as an example the use of these classes to implement the grammar GR given in FIG. 2 by generating (instantiating) grammar objects GO. The command object is generated at run time by instantiation of the grammar class GK which implements the alternative rule AR. Its function is to replace the non-terminal start word <command> by one of the non-terminal words <play>, <stop> or <goto> which is given to the constructor of the respective alternative rule AR as an argument.

The Play object is also generated by calling the constructor of the alternative rule AR. In contrast to the constructor call of the command object, the argument of the constructor call of the Play object does not contain non-terminal words, but exclusively terminal words. The terminal words are given by a concatenated call of the constructor of the terminal TR and implement the words “play”, “go” and “start”. Similarly the substitution rules of the non-terminal words <stop> and <lineno> are generated by corresponding calls of the constructor of the alternative rule AR. The Goto object is finally generated as an instance of the grammar class GK which implements the chain rule KR. The constructor receives the terminal word “go to line” and the non-terminal word “lineno” as an argument.

For semantic conversion of a statement evaluated by the grammar object GO, in the formal grammar GR in FIG. 2 only the terminal words are converted into program modules PM, given to the application 3 as references and executed directly by this. The program modules PM or corresponding references are directly associated with the terminal words by the definition of the grammar GR (see FIG. 2). In the concrete execution situation this appears for example as follows: each of the <command> rules generates a command object, the Execute( ) method of which can be executed directly by application 3. The Goto rule would generate a special command object which also contains the corresponding line number.

In contrast to the strict separation between syntax analysis SA, semantic synthesis SA and execution of the semantic machine language program, FIG. 5 shows a direct synthesis of the semantic instructions and their execution by the speech input interface 2 using the example of a grammar object GO which implements the multiplication by a chain rule KR. The multiplication object is instantiated as a sequential arrangement of three elements: a natural figure between 1 and 9 (the class NumberGrammar can for example result by inheritance from the class ChoiceGrammar), the terminal word “times” and a new natural figure from the interval 1 to 9. Instead of giving as a parsing result the list (“3”, “times”, “5”) for semantic conversion, the instruction “3 times 5” can be executed directly in the object and the result 15 returned. The calculation in the present example is undertaken by a special synthesis event handler SE which collects and links the data of the multiplication object—in the present example, the two factors of the multiplication.

Such an efficient semantic synthesis SS interlinked with the syntax analysis SA is possible only by the implementation according to the invention of the semantics of a syntactic construct in a translator language and translation into directly executable machine language program modules PM, since only in this way can the semantic synthesis SS be integrated directly in the syntax analysis SA. By the use of an object-oriented instead of a procedural/imperative programming language, the data structures used can also be suitably structured and encapsulated for service providers and end users while the data transfer between syntax analysis and semantic synthesis can be controlled efficiently.

A special functionality of design tools for grammar design is explained using FIG. 6 on the example of a time grammar. For a design of a special grammar the substitution rules KR, AR and TR prespecified by the grammar class GK are graphically combined and instantiated by the use of corresponding terminal and non-terminal words i.e. the corresponding grammar objects GO generated.

The various substitution rules are therefore distinguished in FIG. 6 by different forms of the boxes in the flow diagram. After the graphic selection of a particular substitution rule, for specification (i.e. for instantiation of the rule) for example by double-clicking or any other user action, a grammar editor is opened in which to specify the sub-grammar the alternatives, sequences or terminal words can be given according to the rule selected. After specification of the corresponding sub-grammar, the sub-tree is closed again and the specified part grammar appears in formal notation in the higher box. To allow complex grammars, for specification of a sub-grammar, further rules can be inserted.

In the example of the time grammar, the design begins with the selection of an alternative rule AR which contains four sub-grammars in the form of alternative chain rules KR, indicated by the oval boxes.

For the first and fourth alternatives, the trees of the sub-grammar are closed, but they can be made visible by double-clicking on the corresponding box or by a corresponding action. In the fourth alternative (1 . . . 20|quarter)(minutes to|to)1 . . . 12) by double-clicking etc. on the chain rule box KR, a series of two alternative rules AR and one terminal rule TR becomes visible.

For the second and third alternatives the trees of the sub-grammars are partly visible. The second alternative ((1 . . . 12(1 . . . 59|))(AM|PM|) consists of a sequence of the chain rule (1 . . . 12(1 . . . 59|)) and the alternative rule (AM|PM|). The chain rule KR again comprises a sequence of a terminal rule TR and an alternative rule AR which contains two alternative terminal rules TR. The alternative rule AR offers three different terminal rules TR as alternatives which use the terminal words “AM” and “PM” and a third terminal word not yet specified. By double-clicking or similar on a terminal rule TR, the terminal words to be finally used i.e. the vocabulary of the formal language, can be given. In this way with the grammar editor any grammar GR can be specified and shown graphically in the desired complexity.

The formal grammar specified graphically in this way is now converted completely and automatically into corresponding programming language grammar classes GK of an object-oriented translator language, which classes are instantiated after translation at the run time of the dialog system 1 and verified as substitution rules for the validity of a speech statement by derivation/parsing.

By activating a corresponding function of a semantic editor, an event handler SE can automatically be generated for semantic or attribute synthesis. An editor window then opens automatically in which the corresponding program code for the event can be supplemented in the object-oriented translator language. After its translation the specified grammar class of the application can be presented for execution in the form of static or dynamic linked libraries.

Finally it should be pointed out again that the speech input interface shown in the figures and explained in the description and the dialog system are merely example of embodiments which can be varied greatly by the person skilled in the art without leaving the scope of the invention. In particular the program fragments which in the example of embodiments shown are produced in the object-oriented programming language C#, can be written in any other object-oriented programming language or in other imperative programming languages. Also for the sake of completeness it should be pointed out that the use of the indefinite article “a” does not exclude the possibility that the feature concerned may also be present several times, and that the use of the term “comprise” does not exclude the existence of further elements or steps.

1. A method for operation of a dialog system (1) with a speech input interface (2) and an application (3) co-operating with the speech input interface (2) in which the speech input interface (2) detects audio-speech signals (AS) from a user and converts these directly into a recognition result (ER) in the form of binary data which can be used directly by the application (3).

2. A method as claimed in claim 1, characterized in that the binary data comprises at least one program module (PM) present in machine language and executable directly by the application (3) in the form of an object of an object-oriented translator language and/or a data object of an object-oriented translator language.

3. A method as claimed in claim 1, characterized in that on conversion of the audio speech signal (AS) into a recognition result (ER) first in a syntax analysis step (SA) the phrase corresponding to the audio speech signal (AS) is detected on the basis of a formal grammar (GR) where the valid vocabulary of the audio speech signal (AS) corresponds to the terminal words of the formal grammar (GR), and then the recognition result (ER) is generated in a semantic synthesis step (SS) from the executable program modules (PM) present in machine language and allocated to the terminal words.

4. A method as claimed in claim 3, characterized in that the grammar (GR) is defined completely before the start of a dialog and cannot be changed during the dialog.

5. A method as claimed in claim 3, characterized in that the grammar (GR) is dynamically changed during a dialog.

6. A method as claimed in claim 3, characterized in that the grammar (GR) comprises substitution rules (AR, KR) which are implemented as object-oriented grammar classes (GK) each of which have a rule-dependent parsing function as a method.

7. A method as claimed in claim 3, characterized in that the grammar (GR) is specified in the form of at least one grammar object (GO) as an instance of at least one object-oriented grammar class (GK) and in the syntax analysis step (SA) the audio speech signal (AS) is checked according to substitution rules (AR, KR) of the grammar (GR).

8. A method as claimed in claim 3, characterized in that the syntax analysis step (SA), the semantic synthesis step (SS) and/or the use/execution of the recognition result (ER) take place at least partly overlapping temporally.

9. A method as claimed in claim 6, characterized in that a program part of the speech input interface generating the recognition result is linked as a method of an object-oriented class, in particular as a method of the grammar object (GO).

10. A method as claimed in claim 6, characterized in that the recognition result (ER) is defined by a method of a grammar class (GR) and returned by this as an object.

11. A method for production of a speech input interface (2) for a dialog system (1) with an application (3) co-operating with the speech input interface (2) and comprising the steps:
specification of valid speech input signals (AS) by a formal grammar (GR), where the valid vocabulary of the speech input signal is defined in the form of terminal words of the grammar (GR),
provision of binary data representing the semantics of valid audio speech signals (AS) and comprising data structures which are directly usable by the application (3) at system run time and generated by a program part of the speech input interface (2) and/or program modules (PM) directly executable by the application (3), and/or the provision of program parts which generate the binary data
allocation of the binary data and/or program parts to individual or combinations of terminal words or non-terminal words to reflect a valid audio speech signal (AS) in appropriate semantics,
translation of the program parts and/or program modules (PM) into machine language such that on operation of the dialog system (1), the translated program parts generate data structures directly usable by the application (3) or on operation of the dialog system (1), the translated program modules (PM) can be executed directly by the application (3).

12. A method as claimed in claim 11, characterized in that the formal grammar (GR) is specified by at least one grammar object (GO) as an instance of at least one object-oriented grammar class (GK).

13. A method as claimed in claim 12, characterized in that at least one grammar class (GK) is derived by inheritance from one or more prespecified classes of a grammar class hierarchy and/or a grammar class library.

14. A method as claimed in claim 11, characterized in that the program modules (PM) are programmed in an object-oriented translator language.

15. A method as claimed in claim 12, characterized in that at least one grammar class (GK) and/or the program module (PM) are translated into machine language and provided as static and/or dynamic linked libraries.

16. A method as claimed in claim 11, characterized in that the formal grammar (GR) is specified using a graphic grammar editor and the semantics are defined using a graphic semantic editor.

17. A method as claimed in claim 16, characterized in that the formal grammar (GR) is specified using the graphic grammar editor by selection and/or derivation from prespecified grammar classes (GK) and occupation of the grammar classes with substitution rules (AR, KR) and/or terminal words and/or non-terminal words, where a graphic symbol is allocated to each grammar class (GK) and/or each substitution rule (AR, KR).

18. A method as claimed in claim 16, characterized in that for definition of the semantics of the formal grammar (GR), for each program module (PM) the graphic semantic editor provides an editor window for production of the program module (PM) and associates the program module with a terminal or non-terminal word.

19. A method to generate a dialog system (1) with a speech input interface (2) and an application (3), where the speech input interface (2) is generated with a method as claimed in claim 10.

20. A method as claimed in claim 19, characterized in that the speech input interface (2), the application (3) and where applicable the program modules (PM) belonging to the recognition result (ER) are each written at least partly in the same object-oriented translator language or can run on the same object-oriented platform.

21. A speech input interface (2) for a dialog system (1) for voice control of a device or method by a user, which with co-operates with an application (3) of the dialog system (1) and detects audio speech signals (AS) and converts these directly into a recognition result (ER) in the form of binary data which can be used directly by the application (3).

22. A dialog system (1) comprising a speech input interface (2) as claimed in claim 21.

23. A system for production of a speech input interface (2) of a dialog system (1) comprising a syntax specification tool with which valid audio signals (AS) of the dialog system (1) are specified by a formal grammar (GR), where the valid vocabulary of the audio speech signal (AS) is defined in the form of terminal words of the grammar (GR), and a semantic definition tool for provision of program modules (PM) and allocation of the program modules (PM) to individual or combinations of terminal words such that after translation into machine language, on operation of the dialog system (1) the translated program modules (PM) can be executed directly by the application (3).

24. A system as claimed in claim 23, characterized by an object-oriented grammar class library and/or an object-oriented grammar class hierarchy so that the formal grammar (GR) is specified as an instance of a grammar class (GK) taken from a grammar class library or derived from the classes of the grammar class library, and/or as an instance of a grammar class (GK) taken from the grammar class hierarchy or derived from the classes of the grammar class hierarchy.

25. A system as claimed in claim 23, characterized by a graphic grammar editor to specify the formal grammar (GR) and/or a graphic semantic editor to define the semantics.
